(19) United States
(12) Patent Application Publication
(10) Pub. No.: US 2025/0207770 A1
(43) Pub. Date: Jun. 26, 2025

(54) MULTIFUNCTIONAL TOUCH SWITCH AND FLOOR LAMP

(71) Applicant: Qianhai Qianyi (Shenzhen) Technology Co., Ltd., Shenzhen (CN)

(72) Inventor: Bingchen Lin, Shenzhen (CN)

(21) Appl. No.: 19/081,075

(22) Filed: Mar. 17, 2025

(30) Foreign Application Priority Data
Jun. 28, 2024 (CN) 2024215105293

(51) Int. Cl. F21V 23/04

(52) U.S. Cl. CPC F21V 23/0485

(57) ABSTRACT

The utility model relates to the technical field of lighting equipment, in particular to a multifunctional touch switch and a floor lamp, comprising a PCB control board, which is electrically connected with a bulb of the floor lamp and is provided with three functional areas respectively used to control the turn-on or turn-off, brightness and color of the bulb; a sensor board, which is electrically connected with the three functional areas; a touch piece, which is affixed to one side of the sensor board deviating from the functional areas, three display areas for consumers to touch are arranged on one side of the touch piece deviating from the sensor board, and the three display areas respectively correspond to the three functional areas. The utility model has the technical effect of simplifying the operation steps.

### TECHNICAL FIELD

The utility model relates to the technical field of lighting equipment, in particular to a multifunctional touch switch and a floor lamp.

### BACKGROUND ART

Floor lamps are typically categorized into uplighting floor lamps and direct lighting floor lamps. They are commonly arranged in living rooms and rest areas for use with sofas and coffee tables to meet the needs for local room lighting and decorate the home environment. Floor lamps are often used for local lighting, not for overall illumination, but rather for the convenience of mobility, making them quite practical for creating ambiance in corners. In the case of direct downward projection, the floor lamps are suitable for activities that require concentration, such as reading. In the case of indirect lighting, the overall light changes of the floor lamps can be adjusted.

In existing floor lamp switches, a single-button switch is often utilized, where the functions of turning the floor lamp on or off and adjusting its color are consolidated into one button. When a consumer wishes to change the color of the floor lamp, he needs to press the switch button multiple times. This design is not only cumbersome to operate, but also leads to frequent turn-on and turn-off of the floor lamp to reduce the lifespan of the bulb.

The above deficiencies are expected to be overcome by the technicians in the field.

### SUMMARY OF THE UTILITY MODEL

In order to simplify the operation steps, the utility model provides a multifunctional touch switch and a floor lamp.

The utility model provides a multifunctional touch switch, which adopts the following technical proposal:

a multifunctional touch switch comprises:
a PCB control board, which is electrically connected with a bulb of the floor lamp and is provided with three functional areas respectively used to control the turn-on or turn-off, brightness and color of the bulb;
a sensor board, which is electrically connected with the three functional areas;
a touch piece, which is affixed to one side of the sensor board deviating from the functional areas, three display areas for consumers to touch are arranged on one side of the touch piece deviating from the sensor board, and the three display areas respectively correspond to the three functional areas.

By adopting the above technical proposal, when it is necessary to turn on the bulb/adjust the color/adjust the brightness/turn off the bulb, the consumer touches the display area of the touch piece, and then the sensor board senses the touched position of the touch board; the sensor board is electrically connected with the three functional areas respectively, and transmits sensing signals to the corresponding functional areas of the PCB control board; then the PCB control board controls the bulb to achieve the functions required by the consumer and then realize the technical effect of simplifying the operation steps.

Preferably, the multifunctional touch switch also comprises a switch cover, which is fixedly connected between the sensor board and the PCB control board and is used for conductive connection between the sensor board and the PCB control board.

By adopting the above technical proposal, the switch cover is used to realize the conductive connection between the sensor board and the PCB control board, facilitating the sensor board to transmit the sensing signals to the PCB control board.

Preferably, a mounting groove is arranged on one side of the switch cover deviating from the PCB control board, corresponds to the shape of the sensor board, and is used for plugging and fixing the sensor board.

By adopting the above technical proposal, for fixing the sensor board, the sensor board is inserted into the mounting groove, the mounting groove corresponds to the shape of the sensor board, and then the mounting groove locates the sensor board to prevent the sensor board from being deviated during installation and use, so that the sensor board and the three functional areas of the PCB control board are located on the same level to improve the accuracy of signal transmission to the functional areas.

Preferably, the switch cover is also provided with a clamping slot, which is connected with the mounting groove and is used for clamping and fitting the touch piece.

By adopting the above technical proposal, when it is necessary to install the touch piece, the operator plugs the touch piece into the clamping slot to locate the installation position of the touch piece, so that the touch piece is parallel to the sensor board, and the three display areas of the touch piece are located on the same horizontal line with the three functional areas of the PCB control board.

The utility model also provides a floor lamp, which adopts the following technical proposal:

the floor lamp comprises a bulb, a lampshade, a support frame and the multifunctional touch switch, the bulb and the lampshade are fixedly installed on the support frame, and the support frame is provided with a fixing mechanism, and the fixing mechanism is provided for the multifunctional touch switch to be fixedly installed inside the support frame and exposed to the surface of the support frame.

By adopting the above technical proposal, when it is necessary to turn on/off the floor lamp/adjust the color/adjust the brightness, the operator installs the multifunctional touch switch inside the support frame using the fixing mechanism to realize concealment, so that the floor lamp is simpler and more beautiful in appearance, and the touch screen is exposed to the surface of the support frame to facilitate consumers to use the multifunctional touch switch.

Preferably, the fixing mechanism comprises a mounting pipe, a positioning bracket and a bottom plug, the positioning bracket is fixedly connected with the PCB control board and is plugged into the mounting pipe, the bottom plug is inserted into the end of the mounting pipe and is butted with the positioning bracket, and the mounting pipe and the support frame are formed integrally.

By adopting the above technical proposal, when the multifunctional touch switch needs to be installed, the operator installs the positioning bracket equipped with the PCB control board into the mounting pipe, and makes the bottom plug propped under the positioning bracket to locate the vertical position of the positioning bracket and prevent the multifunctional touch switch from deviating.

Preferably, the positioning bracket is provided with positioning ribs, the PCB control board is provided with positioning slots, and the positioning slots adopts clamping fit with the positioning ribs.

By adopting the above technical proposal, the clamping fit between the positioning ribs and the positioning slots is utilized to fix the installation position of the PCB control board in the positioning bracket and then facilitate the installation of the multifunctional touch switch at the later stage.

Preferably, the number of positioning ribs is four, and the four positioning ribs are respectively located at the four corners of the positioning bracket, the number of the positioning slots is consistent with the number of the positioning ribs, and the position of the positioning slots corresponds to the position of the positioning ribs.

Preferably, the fixing mechanism also comprises a top plug, which is plugged into the top end of the mounting pipe and is butted with the positioning bracket.

By adopting the above technical proposal, the top plug is propped against the top of the positioning bracket to prevent the positioning bracket from being positioned in the vertical direction and improve the stability of the positioning bracket.

Preferably, a display hole is arranged on the side wall of the mounting pipe, is connected with the interior of the mounting pipe and is used for the switch cover to be closed and exposed to the mounting pipe.

By adopting the above technical proposal, the switch cover is closed into the display hole, so that the touch piece can be installed on the surface of the mounting pipe, facilitating the consumer to control the bulb according to demand and making the floor lamp more beautiful.

To sum up, the utility model has the following beneficial technical effects:

1. when the consumer touches the display area of the touch piece with fingers, the sensor board senses the touched position of the touch board, the sensor board is electrically connected with the three functional areas, the sensor board transmits electrical signals to the corresponding functional areas of the PCB control board, and then the PCB control board controls the bulb to achieve the functions required by the consumer;
2. the switch cover is fixedly connected between the sensor board and the PCB control board to realizes the technical effects of the sensor board and the PCB control board, so that the PCB control board can receive the electrical signals sensed by the sensor board;
3. the operator installs the multifunctional touch switch inside the support frame using the fixing mechanism to realize concealment, so that the floor lamp is simpler and more beautiful in appearance, and the touch screen is exposed to the surface of the support frame to facilitate consumers to use the multifunctional touch switch.

### BRIEF DESCRIPTION OF THE DRAWINGS

FIG. 1 is the schematic diagram for an overall mechanism of a multifunctional touch switch in Embodiment 1 of the utility model.

FIG. 2 is the schematic diagram for an overall structure of a floor lamp in Embodiment 2 of the utility model.

Reference signs: 1. PCB control board; 11. Positioning slot; 12. First functional area; 13. Second functional area; 14. Third functional area; 2. Switch cover; 21. Mounting groove; 22. Clamping slot; 23. Butting block; 3. Sensor board; 4. Touch piece; 41. Display area; 5. Support frame; 6. Lampshade; 71. Top plug; 72. Bottom plug; 73. Positioning bracket; 74. Positioning rib; 75. Mounting pipe; 76. Display hole; 8. Multifunctional touch switch.

### DETAILED DESCRIPTION OF THE UTILITY MODEL

### Embodiment 1

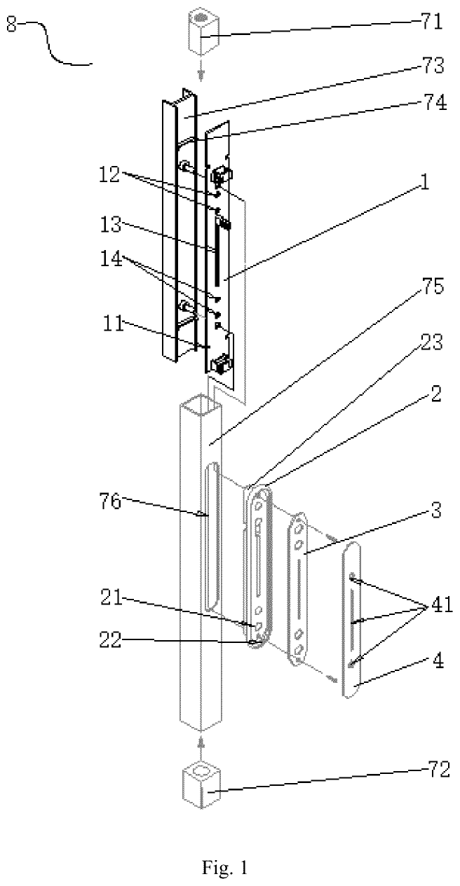

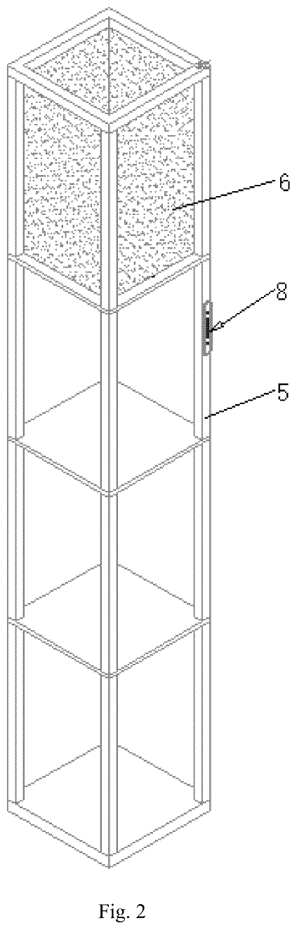

The utility model is described in further detail below in conjunction with the FIG. 1 and FIG. 2.

Embodiment 1 of the utility model discloses a multifunctional touch switch 8. As shown in FIG. 1, the multifunctional touch switch 8 comprises a PCB control board 1, a switch cover 2, a sensor board 3 and a touch piece 4.

Specifically, the PCB control board 1 is arranged in a long strip shape and is electrically connected with the bulb of the floor lamp (not shown in the drawing). The PCB control board 1 is provided with three functional areas: a first functional area 12, a second functional area 13 and a third functional area 14.

Preferably, in the embodiment of the utility model, the first functional area 12 is used to control the turn-on or turn-off of the bulb, the second functional area 13 is used to control the brightness of the bulb, and the third functional area is used to control the color of the bulb.

Preferably, in the embodiment of the utility model, the first functional area 12 can also be used to control the color of the bulb, and the third functional area can also be used to control the turn-on or turn-off of the light bulb.

Specifically, the switch cover 2 is also arranged in a long strip shape, the length direction of the switch cover 2 is parallel to that of the PCB control board 1, a butting block 23 is arranged in the horizontal direction of the switch cover 2 and is butted against the three functional areas of the PCB control board 1, and then the switch cover 2 is electrically connected with the three functional areas.

Specifically, the sensor board 3 is parallel to one side of the switch cover 2 deviating from the PCB control board 1 and is fixedly connected with the switch cover 2 through screws. A mounting groove 21 for the sensor board 3 to be inserted and accommodated is arranged on one side of the switch cover 2 deviating from PCB control board 1, the length direction of the mounting groove 21 is parallel to that of the PCB control board 1, the midpoint in the length direction of the mounting groove 21 coincides with that in the length direction of the PCB control board 1, and both the sensor board 3 and the three functional areas of the PCB control board 1 are located on the same level, so that the sensor board 3 can accurately transmit sensing signals to the three functional areas.

Specifically, the touch piece 4 is pressed against one side of the sensor board 3 deviating from the switch cover 2, is parallel to the sensor board 3 and is used for the consumers to touch. The switch cover 2 is provided with a clamping slot 22 for the clamping fit of the touch piece 4, and the clamping slot 22 is connected with the mounting groove 21. The touch piece 4 is provided with three display areas 41 along the length direction thereof. When the touch piece 4 is clamped inside the clamping slot 22, both the three display areas 41 and the three functional areas are located on the same horizontal line.

When it is necessary to turn on the bulb/adjust the color/adjust the brightness/turn off the bulb, the consumer touches one display area 41 of the touch piece 4, and then the sensor board 3 senses the touched position, the switch cover 2 is electrically connected between the sensor board 3 and the PCB control board 1, then the sensor board 3 transmits sensing signals to the corresponding functional areas of the PCB control board 1, and the PCB control board 1 controls the bulb to achieve the functions required by the consumer.

### Embodiment 2

The utility model is described in further detail below in conjunction with the FIG. 1 and FIG. 2.

Embodiment 2 of the utility model discloses a floor lamp. As shown in FIG. 1 and FIG. 2, a floor lamp comprises a bulb, a lampshade 6, a support frame 5 and the multifunctional touch switch 8 described above.

The support frame 5 comprises a fixing mechanism provided for the multifunctional touch switch 8 to be fixedly installed inside the support frame 5 and exposed to the surface of the support frame 5.

Specifically, the fixing mechanism comprises a mounting pipe 75, a positioning bracket 73, a top plug 71 and a bottom plug 72. The mounting pipe 75 is integrally formed with the support and is used for accommodating the multifunctional touch switch 8, and a display hole 76 is arranged on the side wall of the mounting pipe 75. When the multifunctional touch switch 8 is accommodated in the mounting pipe 75, the switch cover 2 cover is closed into the display hole 76, and then the display area 41 is exposed outside the mounting pipe 75, facilitating the consumers to touch.

The positioning bracket 73 is arranged in a long strip shape, bolts for fixed connection with the PCB control board 1 are arranged on one side of the positioning bracket 73 along the length direction thereof. Positioning ribs 74 are arranged on the side of the positioning bracket 73, and the PCB control board 1 is provided with positioning slots 11 for the clamping fit of the positioning ribs 74.

Preferably, in the embodiment, the number of positioning ribs 74 is four, the four positioning ribs 74 are located at the four corners of the positioning bracket 73, the number of positioning slots 11 is consistent with the number of positioning ribs 74, and the positions of the four positioning slots 11 correspond to the positions of the four positioning ribs 74.

When the multifunctional touch switch 8 needs to be installed on the support frame 5, the operator first electrically connects the PCB control board 1 with the bulb, adopts clamping fit between the positioning slot 11 of the PCB control board 1 and the positioning ribs 74, uses the bolts to fixedly connect the PCB control board 1 with the positioning bracket 73, then inserts the positioning bracket 73 equipped with the PCB control board 1 into the mounting pipe 75, exposes the three functional areas of the PCB control board 1 to the display hole 76, plugs the bottom plug 72 and the top plug 71 into the top and bottom of the positioning bracket 73 to keep the positioning bracket 73 stable in the mounting pipe 75, then inserts the switch cover 2 into the display hole 76, presses the butting block against the three functional areas of the PCB control board 1, and then installs the sensor board 3 and the touch piece 4 successively on the switch cover 2, thus completing the installation of the multifunctional touch switch 8.

The above are preferred embodiments of the utility model, and are not intended to limit the scope of protection of the utility model. Therefore, any equivalent changes made according to the mechanism, shape and principle of the utility model shall fall within the scope of protection of the utility model.

1. A multifunctional touch switch, characterized by comprising:
a PCB control board (1), which is electrically connected with a bulb of the floor lamp and is provided with three functional areas respectively used to control the turn-on or turn-off, brightness and color of the bulb;
a sensor board (3), which is electrically connected with the three functional areas;
a touch piece (4), which is affixed to one side of the sensor board (3) deviating from the functional areas, three display areas (41) for consumers to touch are arranged on one side of the touch piece (4) deviating from the sensor board (3), and the three display areas (41) respectively correspond to the three functional areas.

2. The multifunctional touch switch according to claim 1, characterized by also comprising a switch cover (2), which is fixedly connected between the sensor board (3) and the PCB control board (1) and is used for conductive connection between the sensor board (3) and the PCB control board (1).

3. The multifunctional touch switch according to claim 2, characterized in that a mounting groove (21) is arranged on one side of the switch cover (2) deviating from the PCB control board (1), corresponds to the shape of the sensor board (3), and is used for plugging and fixing the sensor board (3).

4. The multifunctional touch switch according to claim 2, characterized in that the switch cover (2) is also provided with a clamping slot (22), which is connected with the mounting groove (21) and is used for clamping and fitting the touch piece (4).

5. A floor lamp, characterized by comprising a bulb, a lampshade (6), a support frame (5) and the multifunctional touch switch (8) in any of claims 1 to 4, the bulb and the lampshade (6) are fixedly installed on the support frame (5), the support frame (5) is provided with a fixing mechanism, and the fixing mechanism is provided for the multifunctional touch switch (8) to be fixedly installed inside the support frame (5) and exposed to the surface of the support frame (5).

6. The multifunctional touch switch according to claim 5, characterized in that the fixing mechanism comprises a mounting pipe (75), a positioning bracket (73) and a bottom plug (72), the positioning bracket (73) is fixedly connected with the PCB control board (1) and is plugged into the mounting pipe (75), the bottom plug (72) is inserted into the end of the mounting pipe (75) and is butted with the positioning bracket (73), and the mounting pipe (75) and the support frame (5) are formed integrally.

7. The multifunctional touch switch according to claim 6, characterized in that the positioning bracket (73) is provided with positioning ribs (74), the PCB control board (1) is provided with positioning slots (11), and the positioning slots (11) adopt clamping fit with the positioning ribs (74).

8. The multifunctional touch switch according to claim 7, characterized in that the number of positioning ribs (74) is four, and the four positioning ribs (74) are respectively located at the four corners of the positioning bracket (73), the number of the positioning slots (11) is consistent with the number of the positioning ribs (74), and the position of the positioning slots (11) corresponds to the position of the positioning ribs (74).

9. The multifunctional touch switch according to claim 6, characterized in that the fixing mechanism also comprises a top plug (71), which is plugged into the top end of the mounting pipe (75) and is butted with the positioning bracket (73).

10. The multifunctional touch switch according to claim 6, characterized in that a display hole (76) is arranged on the side wall of the mounting pipe (75), is connected with the interior of the mounting pipe (75) and is used for the switch cover (2) to be closed and exposed to the mounting pipe (75).
